(19) United States
(12) Patent Application Publication
(10) Pub. No.: US 2015/0032489 A1
(43) Pub. Date: Jan. 29, 2015

(54) METHODS FOR FACILITATING THE PREPARATION OF CONSTRUCTION BID DOCUMENTS AND DEVICES THEREOF

(71) Applicant: BidDocs ONLINE, Inc., Groton, MA (US)

(72) Inventor: Gregory Karl Yanchenko, Groton, MA (US)

(73) Assignee: BidDocs ONLINE, Inc., Groton, MA (US)

(21) Appl. No.: 13/951,237

(22) Filed: Jul. 25, 2013

(51) Int. Cl. G06Q 10/06

(52) U.S. Cl. CPC G06Q 10/06311
USPC 705/7.13

(57) ABSTRACT

A method, non-transitory computer readable medium, and an electronic bidding server that obtains a selection of a template associated with a project from a first user, wherein the template includes at least a plurality of static and dynamic documents. Drawing(s), specification(s), and content associated with the project is received from a second user. Input field(s) of the one or more dynamic documents are populated with the content received from the second user. The specification(s), drawing(s), and static and dynamic documents are provided to a bidding platform configured to receive bids from bidders for completing the project. Subsequent to receiving and approving the bidder, a project administrator user approves automatic extraction of the data input, including the plurality of dynamic and static documents from all phases of the process to generate a compliant and correct contract for the project.

### FIELD

This technology generally relates to methods and devices that facilitate the preparation of bid documents and, more particularly, to facilitating, with a web-based platform hosted by an electronic bidding server, the preparation of construction bid documents using templates, the submission of a project for electronic bidding, and the automatic preparation of a contract based on an accepted bid.

### BACKGROUND

Construction projects are often solicited by awarding authorities to general contractors and subcontractors (also referred to herein as bidders) who are authorized to submit bids for completing the work associated with the project. Currently, the bidding process is facilitated based on paper or hard copy submissions of bid documents and therefore requires a significant amount of resources to prepare, review, revise, validate, and communicate among parties. Due to the manual nature of the hard copy submissions, the construction bid documents are often redundant, contradictory, extraneous, error prone and/or irrelevant, which is undesirable.

The current process also does not provide for designers, consultants, and/or reviewers to easily create, view and/or modify construction bid documents prior to the documents being submitted for bidding. Accordingly, awarding authority representatives, such as project administrators, often prepare, review, and/or confirm a subset of the documents even though not best-suited to perform such task(s).

Construction documents submitted for bidding, including contract documents associated with a project, are often subject to statutory requirements, particularly when the project is public and/or associated with a state or local government agency, for example. Because these construction bid documents are currently prepared manually, they often fail to comply with the statutory requirements and/or include incomplete or inaccurate content which, in some cases, is fatal to the successful bidding of the project and/or successful execution of a contract between an awarding authority and a contractor that submitted an accepted bid.

### SUMMARY

A method for facilitating the preparation of construction bid documents includes obtaining, with an electronic bidding server, a selection of a template associated with a project from a first user, wherein the template includes at least a plurality of static and dynamic documents and the first user is authenticated as an administrator of the project. One or more drawings, one or more specifications, and content associated with the project is received, with the electronic bidding server, from a second user, wherein the second user is identified by the first user as a prime designer associated with the project. One or more input fields of the one or more dynamic documents are populated, with the electronic bidding server, with the content received from the second user. The one or more specifications, one or more drawings, and static and dynamic documents are provided, with the electronic bidding server, to a bidding platform configured to receive bids from one or more bidders for completing the project.

A non-transitory computer readable medium having stored thereon instructions for facilitating the preparation of construction bid documents comprising machine executable code which when executed by a processor, causes the processor to perform steps including obtaining a selection of a template associated with a project from a first user, wherein the template includes at least a plurality of static and dynamic documents and the first user is authenticated as an administrator of the project. One or more drawings, one or more specifications, and content associated with the project is received from a second user, wherein the second user is identified by the first user as a prime designer associated with the project. One or more input fields of the one or more dynamic documents are populated with the content received from the second user. The one or more specifications, one or more drawings, and static and dynamic documents are provided to a bidding platform configured to receive bids from one or more bidders for completing the project.

An electronic bidding server includes a processor coupled to a memory and configured to execute programmed instructions stored in the memory including obtaining a selection of a template associated with a project from a first user, wherein the template includes at least a plurality of static and dynamic documents and the first user is authenticated as an administrator of the project. One or more drawings, one or more specifications, and content associated with the project is received from a second user, wherein the second user is identified by the first user as a prime designer associated with the project. One or more input fields of the one or more dynamic documents are populated with the content received from the second user. The one or more specifications, one or more drawings, and static and dynamic documents are provided to a bidding platform configured to receive bids from one or more bidders for completing the project.

This technology provides a number of advantages including methods, non-transitory computer readable medium, and an electronic bidding server that facilitates the efficient preparation of construction bid documents with increased accuracy and compliance with statutory requirements. With this technology, a web-based platform is provided for users to submit specifications, drawings, and other content associated with the project using a template. The web-based platform facilitates preparation of the project documents, based on the user submissions and static and dynamic documents associated with the template, submission of the project for bidding, and generation of a contract with a successful bidder.

### BRIEF DESCRIPTION OF THE DRAWINGS

FIG. 1 is a block diagram of an exemplary network environment which incorporates client computing devices coupled to an exemplary electronic bidding server;

FIG. 2 is a flowchart of an exemplary method for preparing construction bid documents;

FIG. 3 is an exemplary active projects web page for obtaining project information from a project administrator;

FIG. 4 is an exemplary project details web page for obtaining project information and an indication of a prime designer;

FIG. 5 is a an exemplary front end web page for obtaining content associated with a project;

FIG. 6 is an exemplary specification web page for obtaining specifications associated with a project;

FIG. 7 is an exemplary drawings web page for obtaining drawings associated with a project;

FIG. 8 is an exemplary project details web page with a modify consultants overlay for obtaining identifying information associated with one or more consultants associated with a project;

FIG. 9 is an exemplary specification web page for obtaining specifications associated with a project as accessed by a mechanical consultant;

FIG. 10 is an exemplary table of contents identifying construction bid documents associated with a project;

FIG. 11 is an exemplary design submission log web page including a create submission overlay for submitting a project for bidding; and

FIG. 12 is an exemplary electronic bidding web page for facilitating receipt of bids associated with a project.

### DETAILED DESCRIPTION

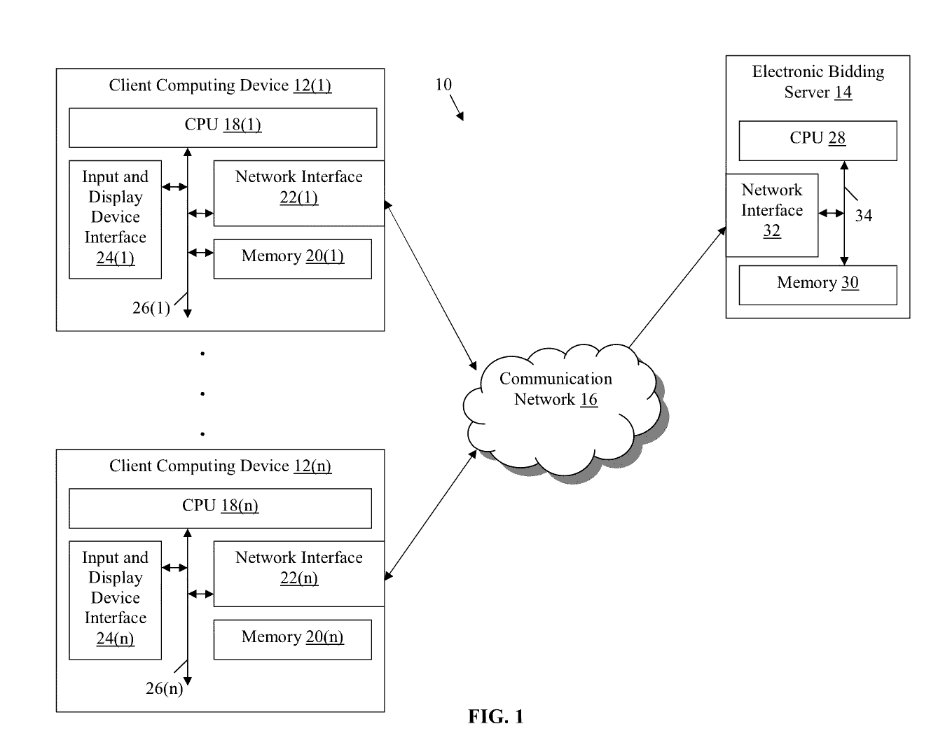

An exemplary environment 10 with client computing devices 12(1)-12(n) coupled to an electronic bidding server 14 by a communication network 16 is illustrated in FIG. 1, although this environment 10 can include other numbers and types of systems, devices, components, and elements in other configurations, such as multiple numbers of electronic bidding servers and communication networks. While not shown, the environment 10 also may include additional network components, such as routers, switches and other devices, which are well known to those of ordinary skill in the art and thus will not be described here. This technology provides a number of advantages including methods, non-transitory computer readable medium, and an electronic bidding server that prepares construction bid documents with increased efficiency, accuracy, and compliance with statutory requirements as well as facilitates electronic bidding of the project and preparation of a contract between an awarding authority and a successful bidder.

The client computing devices 12(1)-12(n) each include a central processing unit (CPU) 18(1)-18(n) including one or more processors, a memory 20(1)-20(n), a network interface 22(1)-22(n), and an input and display device interface 24(1)-24(n), which are coupled together by a bus 26(1)-26(n) or other link, although other numbers and types of systems, devices, components, and elements in other configurations and locations can be used.

The CPU 18(1)-18(n) in each of the client computing devices 12(1)-12(n) executes a program of stored instructions for one or more aspects of the present technology as described and illustrated by way of the examples herein, although other types and numbers of processing devices and configurable hardware logic could be used and the processor could execute other numbers and types of programmed instructions.

The memory 20(1)-20(n) in each of the client computing devices 12(1)-12(n) stores these programmed instructions for one or more aspects of the present technology, as described and illustrated herein, although some or all of the programmed instructions could be stored and/or executed elsewhere. The memory 20(1)-20(n) in the client computing devices 12(1)-12(n) optionally stores programmed instructions for a Web browser for communicating with the network interface 22(1)-22(n) to operatively exchange content with the electronic bidding server 14. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the CPU 18(1)-18(n), can be used for the memory 20(1)-20(n).

The network interface 22(1)-22(n) in each of the client computing devices 12(1)-12(n) is used to operatively couple and communicate between the client computing device 12(1)-12(n) and the electronic bidding server 14 via the communications network 16, although other types and numbers of communication networks or systems with other types and numbers of connections and configurations can be used. By way of example only, the communications network could use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communications protocols, can be used.

The input and display device interface 24(1)-24(n) in each of the client computing devices 12(1)-12(n) is used to enable a user to interact with the client computing devices 12(1)-12(n), such as to input and/or view data and/or to configure, program and/or operate the client computing devices 12(1)-12(n) by way of example only. Input devices may include a keyboard, computer mouse, and/or touchscreen and display devices may include a computer monitor, although other types and numbers of input devices and display devices could be used.

The electronic bidding server 14 includes a central processing unit (CPU) 28 including one or more processors, a memory 30, and a network interface 32, which are coupled together by a bus 34 or other link, although other numbers and types of systems, devices, components, and elements in other configurations and locations can be used. The CPU 28 in the electronic bidding server 14 executes a program of stored instructions for one or more aspects of the present technology as described and illustrated by way of the examples herein, although other types and numbers of processing devices and configurable hardware logic could be used and the CPU 28 could execute other numbers and types of programmed instructions.

The memory 30 in the electronic bidding server 14 stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the CPU 28, can be used for the memory 30.

The network interface 32 in the electronic bidding server 14 is used to operatively couple and communicate between the electronic bidding server 14 and the client computing devices 12(1)-12(n) via the communications network 16, although other types and numbers of communication networks or systems with other types and numbers of connections and configurations can be used.

Although examples of the electronic bidding server 14 and the client computing devices 12(1)-12(n) which are coupled together via the communication network 16 are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

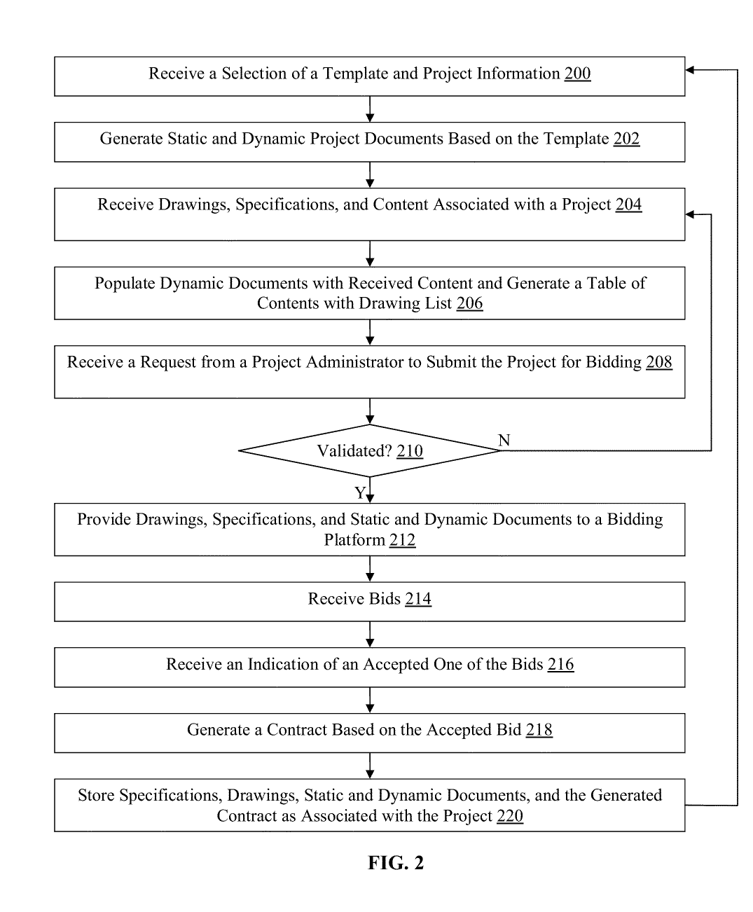

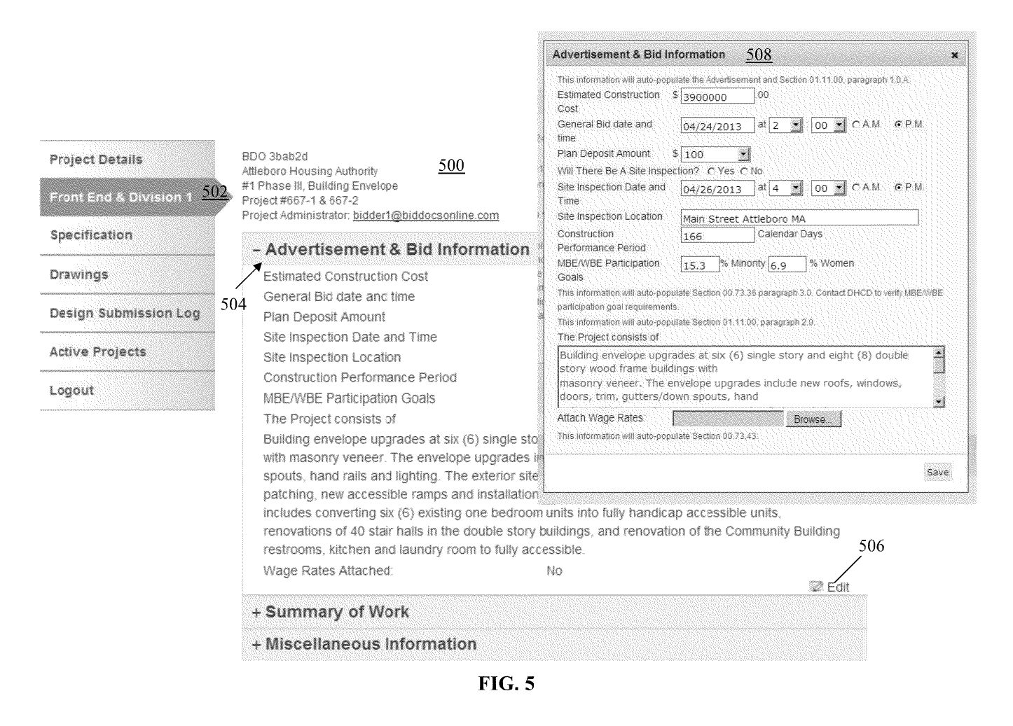

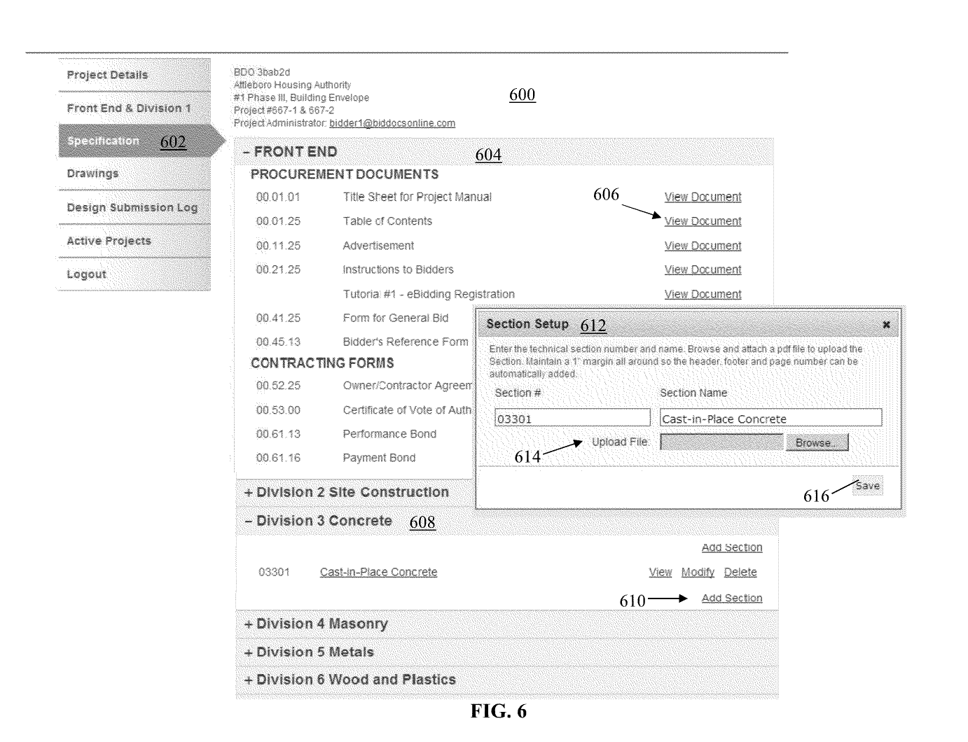

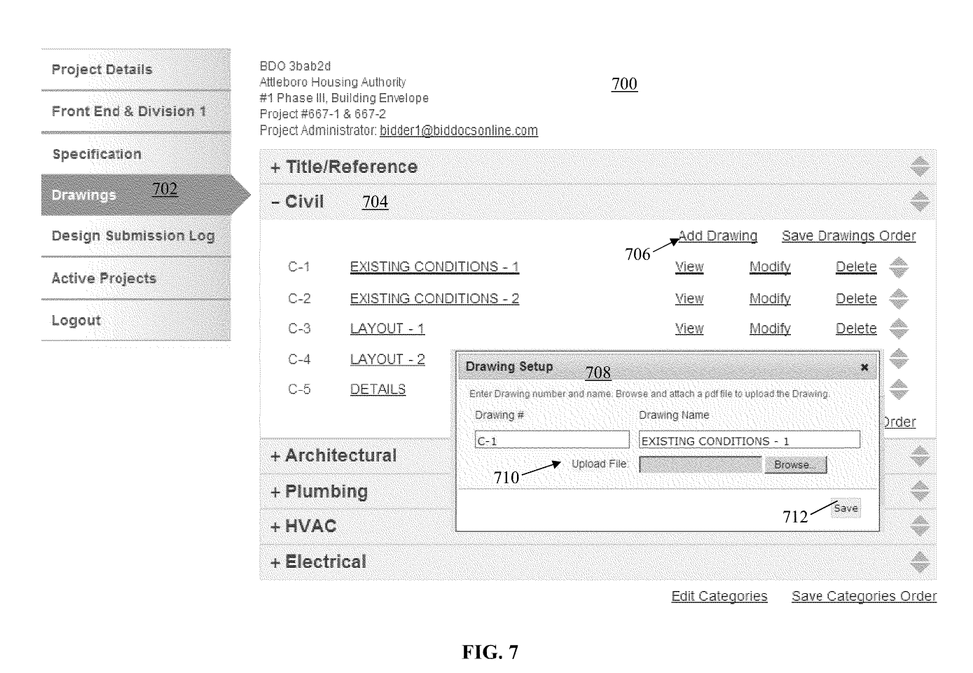

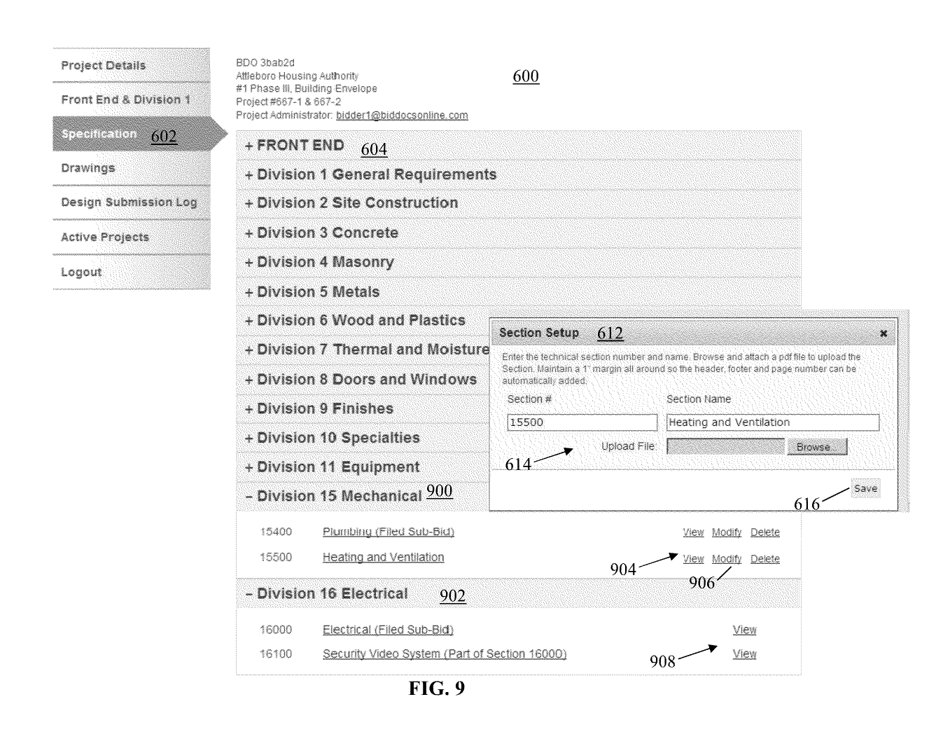

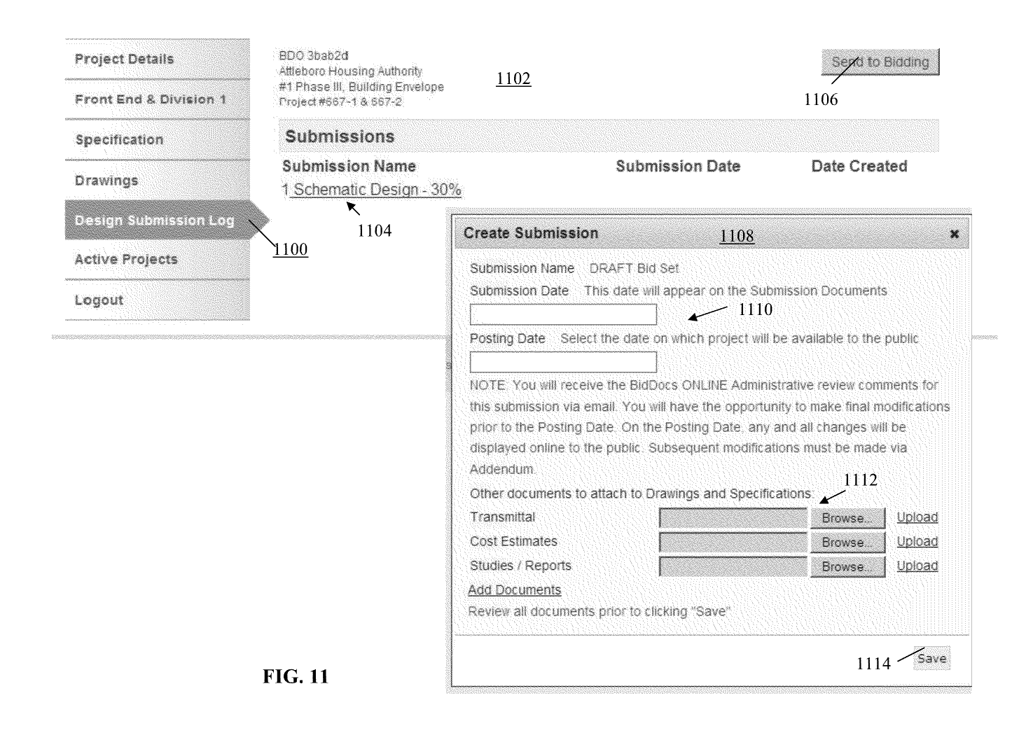

Exemplary methods and devices for preparing construction bid documents will now be described with reference to FIGS. 1-11. Referring specifically to FIG. 2, in step 200, the electronic bidding server 14 receives a selection of a template and project information from an authorized or registered project administrator user of one of the client computing devices 12(1)-12(n). The project administrator user can be a representative of an awarding authority associated with the project, for example.

In this example, the project administer role of the user of the one of the client computing devices 12(1)-12(n) can be determined by the electronic bidding server 14 based on login credentials submitted by the user matching login credentials previously submitted by the user during a registration process and stored in the memory 30 as associated with the project administrator role. In other examples, and particularly in examples in which users can have multiple roles for different projects, the electronic bidding server 14 can identify all roles associated with a user upon receiving login credentials and obtain a selection of the project administrator role from the user which is used for the current session.

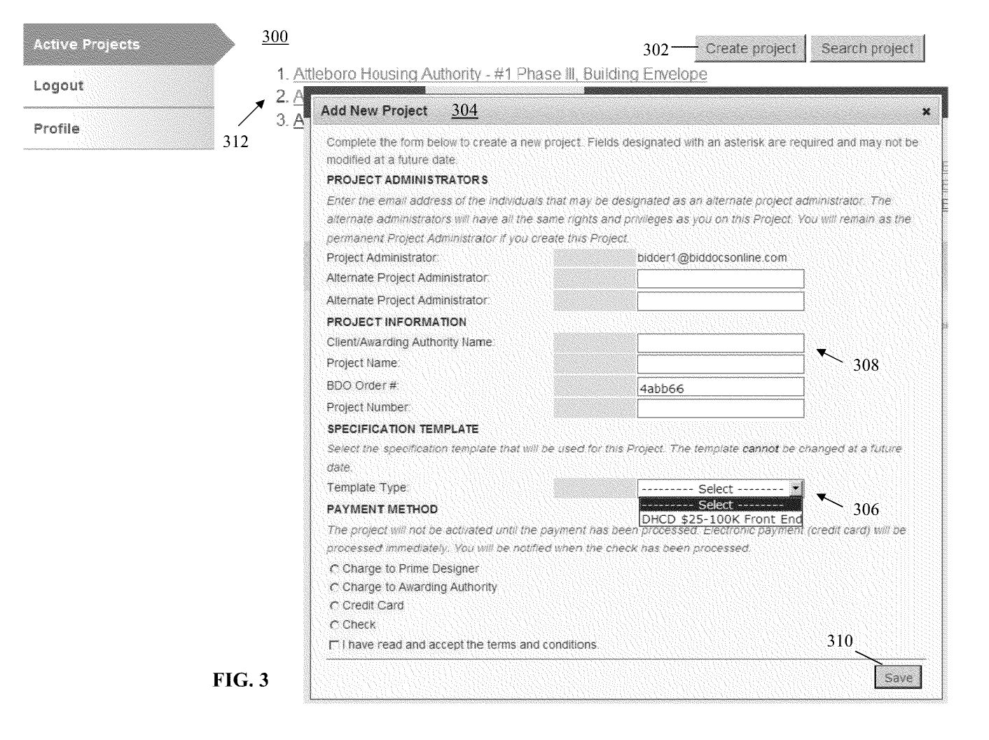

Upon determining the user of the one of the client computing devices 12(1)-12(n) is associated with the project administrator role, in this example, the electronic bidding server 14 can send to the one of the client computing devices 12(1)-12(n) an active projects web page 300, an example of which is illustrated in FIG. 3. The active projects web page 300 includes a create project button 302 which, when selected by the user, causes the add new project overlay 304 to be displayed on the one of the client computing devices 12(1)-12(n). The content of the add new project overlay 304 can also be displayed to the user in a new tab, a new window, or any other type of display. The add new project overlay 304 in this example includes an input field 306 which allows the user to select a template (e.g., the “DHCS $25-100K Front End” template in this example). Other input fields 308 allowing the project administrator user to input other project information can also be provided in the add new project overlay 304.

The template(s) indicated in the input field 306 can be stored in the memory 30 of the electronic bidding server 14 and can include at least a plurality of static and dynamic documents. In some examples, the templates further include an indication of the input fields of the dynamic documents that are required and, optionally, required attributes of the required input fields. Other requirements of a complete project submission, such as other required documents to be provided by a user, and not included in the static and dynamic documents of the template, can also be indicated in each of the templates.

Upon selecting the template and entering other project information, the user can select the save button 310 of the add new project overlay 304 to send the information to the electronic bidding server 14 for storage in the memory 30 as associated with a unique identifier for the new project (e.g., a unique project and/or order number). In this example, the active projects web page 300 also includes a listing of active projects 312 providing links to projects previously created by the project administrator user in the event the user is editing a previously created project rather than creating a new project in the current session.

Referring back to FIG. 2, in step 202, the electronic bidding server 14 generates static and dynamic documents for the newly created project based on the template selected in step 200. The documents can be those required by statute for any project associated with the template, for example, although other documents can also be associated with the template. In some examples, the static documents are standard documents that are required for all projects associated with the template and which do not include any project-specific information. In contrast, the dynamic documents can be documents required for all projects associated with the template but which have input fields requiring project-specific information. Optionally, the generated static and dynamic documents are stored in the memory 30 of the electronic bidding server 14 as associated with the unique identifier for the project.

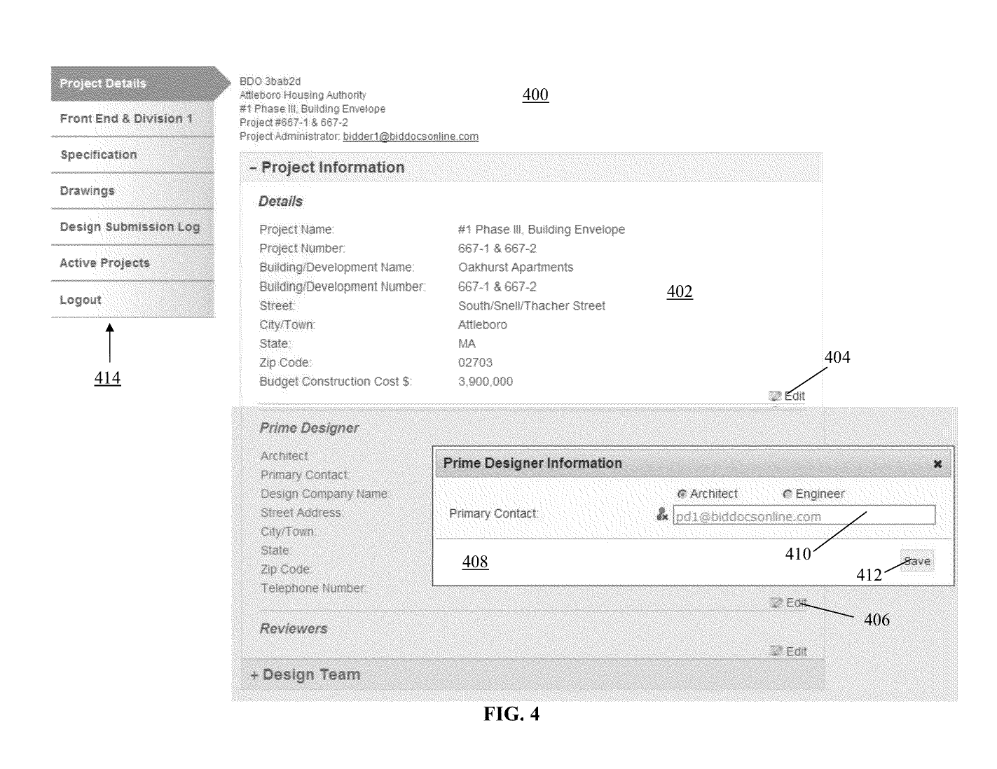

In step 204, the electronic bidding server 14 receives drawings, specifications, and content associated with the project from a user of one of the client computing devices 12(1)-12(n). In this example, the electronic bidding server 14 can send a project details web page 400 to the one of the client computing devices 12(1)-12(n) associated with the project administrator user, an example of which is illustrated in FIG. 4, subsequent to the user selecting the save button 310 of the add new project overlay 304. The project details web page 400 in this example includes at least some of the project information received by the electronic bidding server 14 in step 200 in a project information pane 402. The project administrator user can edit the project information using a first edit button 404 of the project information pane 402.

Additionally, in the project information pane 402 in this example, the project administrator user can select a prime designer using a second edit button 406 of the project information pane 402. Upon selection of the second edit button 406, a prime designer information pane 408 is displayed to the user as an overlay, although the content of the prime designer information pane 408 can be displayed in a new tab, a new window, or any other type of display. The prime designer information pane 408 includes an input field 410 configured to receive an e-mail address of a prime designer to be designated by the project administrator user as associated with the project.

Optionally, the prime designer information pane 408 further includes input field(s) for indicating a more specific role of the prime designer (e.g., an architect or an engineer). In some examples, the prime designer is relatively better suited, as compared to the project administrator, to prepare, review, and/or submit content, specifications, and/or drawings associated with the project. In these examples, the project administrator user can be restricted, based on privileges associated with the project administrator role, from submitting or modifying such content, specifications, and/or drawings. Similarly, the prime designer user may be restricted from submitting or modifying the project information submitted by the project administrator user in step 200. Such role-based access of the web-based platform is described and illustrated in more detail below.

Upon selection by the project administrator user of the save button 412 of the prime designer information pane 408 in this example, an e-mail is automatically sent by the electronic bidding server 14 to the e-mail address inserted into the input field 410 and associated with the prime designer. Optionally, the e-mail automatically sent by the electronic bidding server 14 includes a link and/or instructions that the prime designer recipient can use to register and/or login to the web-based platform in order to access the project.

Upon receiving login credentials from a user of one of the client computing devices 12(1)-12(n) that is associated in the memory 30 with a prime designer role, the electronic bidding server 14 can send the one of the client computing devices 12(1)-12(n) associated with the prime designer user an active projects page, such as the active projects page 300, for example. In this example, the active projects page 300 includes a link to the project created by the project administrator user in step 200. Upon receiving a selection of the link by the prime designer user, the electronic bidding server 14 can send to the one of the client computing devices 12(1)-12(n) associated with the prime designer user a project details page, such as the project details web page 400, for example. However, in some examples, the project details web page 400 sent to the prime designer user does not include any edit buttons, such as the edit buttons 404 and 406, for example. In these examples, only the project administrator can edit the project information associated with the project details web page 400.

In this example, the project details web page 400 includes a plurality of tabs 414 which allow certain users to view, submit, and/or modify specifications, drawings, and/or content associated with a project. For example, the electronic bidding server 14 sends the prime designer user of one of the client computing devices 12(1)-12(n) a front end web page 500 upon receiving a selection by the user of the front end tab 502.

In this example, the front end web page 500 includes a plurality of panes that are expandable and collapsible upon selection by a user. For example, the advertisement and bid information pane 504 is configured to expand when selected to display content associated with the project as well as an edit button 506. In some examples, the front end web page 500 sent to the project administrator user does not include any edit buttons, such as the edit button 506, for example. In these examples, only the prime designer user can edit the content associated with the front end web page 500. Although panes are used in this example, the content associated with the project can be displayed in other ways.

Upon selection of the edit button 506, an advertisement and bid information overlay 508 can be displayed on the one of the client computing devices 12(1)-12(n) associated with the prime designer user. The advertisement and bid information overlay 508 includes a plurality of input fields configured to receive content associated with the project. The input fields can be determined based the template selected in step 200. For example, the input fields included in each of the panes can collectively correspond to the input fields in the dynamic documents associated with the template, as described and illustrated in more detail later with reference to step 206.

Upon selection by the prime designer user of a save button 510 included in the advertisement and bid information overlay 508, the content of the input fields is sent to the electronic bidding server 14. The electronic bidding server 14 can store the received content in the memory 30 as associated with the project. The front end web page 500 can include other panes having edit buttons and corresponding overlays with input fields. Additionally, other methods of submitting and/or editing content associated with a project can also be used.

In this example, the electronic bidding server 14 sends the prime designer user of one of the client computing devices 12(1)-12(n) a specification web page 600 upon receiving a selection by the user of the specification tab 602. The specification web page 600 includes a plurality of panes that are expandable and collapsible upon selection by a user. The front end pane 604 in this example is configured to expand when selected to display documents associated with the project, including an indication of procurement documents and contracting forms in this example. The documents each correspond to one of the static or dynamic documents generated in step 202 and associated with the template selected in step 200. Although panes are used in this example, an indication of the documents and specifications associated with the project can be displayed in other ways.

In this example, the documents identified in the front end pane 604 cannot be edited by the prime designer user and, accordingly, each is associated with one of the view document links 606. Upon selection of one of the view document links 606, the electronic bidding server 14 sends an associated one of the static or dynamic documents to the one of the client computing devices 12(1)-12(n) associated with the prime designer user. In this example, the concrete pane 608 is configured to expand when selected by the prime designer user to display an indication of specification(s) associated with the project.

The concrete pane 608 further includes a plurality of links including an add section link 610 and links configured to modify or delete the specification, as well as view the specification. Accordingly, the prime designer user's privileges allow for modification and/or submission of specifications associated with the concrete pane 608, in contract to those documents associated with the front end pane 604. Upon selection of the add section link 610, a section setup overlay 612 is displayed on the one of the client computing devices 12(1)-12(n) associated with the prime designer user.

The section setup overlay 612 includes input fields 614 for naming and uploading specifications. Upon inserting a location of a specification on the one of the client computing devices 12(1)-12(n) associated with the prime designer user and selecting the save button 616, the specification is sent to the electronic bidding server 14 and stored in the memory 30 as associated with the project. The plurality of links in the concrete pane 608 can include links to view, modify, or delete specifications previously submitted. In some examples, the concrete pane 608 sent to a project administrator user includes only a view link. In these examples, only the prime designer user can edit or submit the specifications associated with the project. The specifications web page 600 can include other panes having various links and corresponding overlays with input fields configured to facilitate receipt of specifications by the electronic bidding server 14. Additionally, other methods of submitting and/or editing specifications associated with a project can also be used.

In this example, the electronic bidding server 14 sends the prime designer user of one of the client computing devices 12(1)-12(n) a drawings web page 700 upon receiving a selection by the user of the drawings tab 702. The drawings web page 700 includes a plurality of panes that are expandable and collapsible upon selection by a user. Although panes are used in this example, an indication of the drawings associated with the project can be displayed in other ways. The civil pane 704 in this example is configured to expand when selected to display drawings associated with the project. The civil pane 704 further includes a plurality of links including an add drawing link 706. Upon selection of the add drawing link 706, a drawing setup overlay 708 is displayed on the one of the client computing devices 12(1)-12(n) associated with the prime designer user.

The drawing setup overlay 708 includes input fields 710 for naming and uploading drawings. Upon inserting a location of a drawing on the one of the client computing devices 12(1)-12(n) associated with the prime designer user, and selecting the save button 712, the drawing is sent to the electronic bidding server 14 and stored in the memory 30 as associated with the project. The plurality of links in the civil pane 704 can include links to view, modify, or delete drawings previously uploaded. In some examples, the civil pane 704 sent to a project administrator user only includes a view link. In these examples, only the prime designer user can edit or upload the drawings associated with the project. The drawings web page 700 can include other panes having various links and corresponding overlays with input fields configured to facilitate receipt of drawings by the electronic bidding server 14. Additionally, other methods of submitting and/or editing drawings associated with a project can also be used.

Accordingly, the electronic bidding server 14 can selectively send to a prime designer user of one of the client computing devices 12(1)-12(n) the front end web page 500, specification web page 600, and drawings web page 700, which are configured to receive content, specifications, and drawings, respectively, from the user which are stored by the electronic bidding server 14 in the memory 30 as associated with the project. While the prime design user in this example can submit, modify, and delete content, specifications, and drawings, the project administrator can only view the content, specifications, and drawings obtained from the prime designer, although other role-based access privileges can also be used

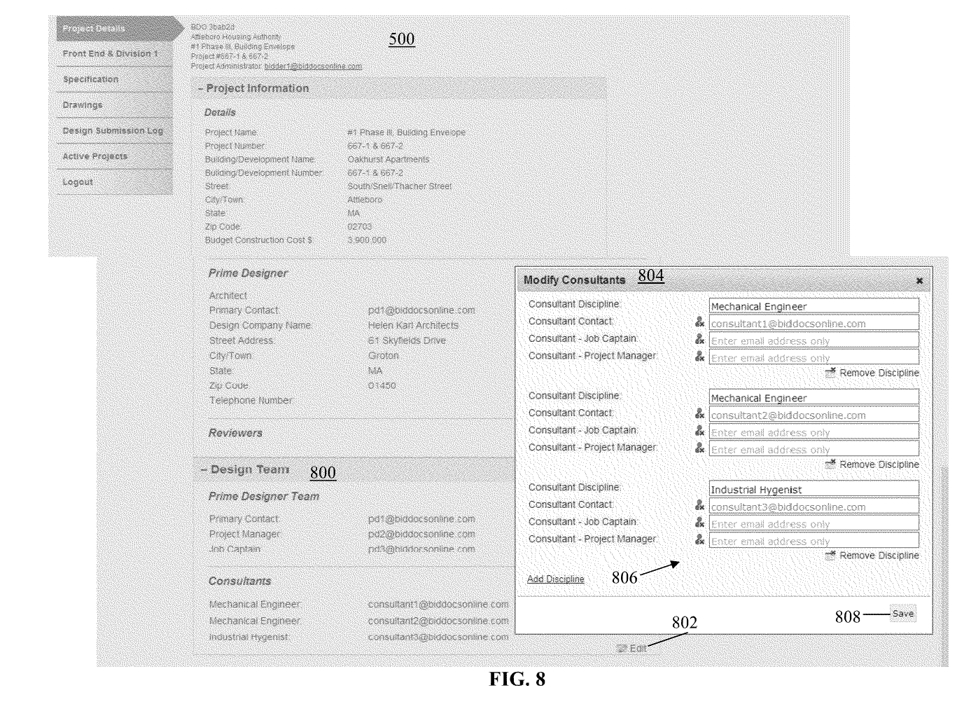

In some examples, consultants designated by the prime designer can also submit, modify, and/or delete content, specifications, and/or drawings. Referring to FIG. 8, the project details web page 500 is shown as including a design team pane 800 including identifying information for prime designer team members and consultants and an edit button 802. Upon selecting the edit button 802, a modify consultants overlay 804 is displayed to a prime designer user of one of the client computing devices 12(1)-12(n). The content of the modify consultants overlay 804 can also be displayed in a new tab, a new window, or any other display. The modify consultants overlay 804 includes a plurality of input fields 806 configured to receive at least an e-mail address of a consultant and a discipline or title associated with the consultant (e.g., a mechanical engineer).

Upon selection of the save button 808 of the modify consultants overlay 804 by the prime designer user, the consultant information is obtained by the electronic bidding server 14 and stored in the memory 30 as associated with the project. Additionally, the electronic bidding server 14 automatically sends an e-mail to the e-mail address input by the prime designer user and associated with the consultant. The e-mail optionally includes a link and/or instructions that the consultant can use to register and/or login to the web-based platform in order to access the project.

Upon receiving login credentials from a user of one of the client computing devices 12(1)-12(n) that is associated in the memory 30 with a consultant role, the electronic bidding server 14 can send the one of the client computing devices 12(1)-12(n) associated with the consultant user an active projects page, such as the active projects page 300 shown in FIG. 3, for example. After selecting a project, the electronic bidding sever 14 sends the project details web page 400 to the consultant user of one of the client computing devices 12(1)-12(n). The project details web page 400 includes a plurality of tabs 414 as described and illustrated earlier.

In this example, upon selection of the specification tab 602 by the consultant user, the electronic bidding server 14 sends the specification web page 600 including a plurality of panes that are expandable and collapsible upon selection by a user. In this example, the plurality of panes includes the front end pane 604 described and illustrated earlier, a mechanical pane 900, and an electrical pane 902, among others. The mechanical pane 900 is configured to expand when selected by the consultant user to display specifications associated with the project as well as a set of links 904 including view, modify, and delete links. Because the prime designer user has indicated the consultant is a mechanical engineer in this example, the consultant user has the option of modifying or deleting, in addition to viewing, the specifications indicated in the mechanical pane 900.

Upon selecting the modify link 906, a section setup overlay 612 is displayed including input fields 614 for naming and uploading specifications, as described and illustrated earlier. In contrast, the electrical pane 902 includes an indication of specifications along with view links 908 only since the consultant user does not have privileges to modify or delete electrical specifications based on the discipline or title associated with the consultant user by the prime designer user. Similar role-based access privileges can be implemented on other panes and with respect to other web pages of the web-based platform, such as the front end web page 500 and drawings web page 700, for example. In other examples, various other roles and/or role-based access privileges can be established and maintained by the electronic bidding server 14 such as a reviewer role having privileges restricted to viewing content, specifications, and/or drawings associated with a project

Referring back to FIG. 2, in step 206, the electronic bidding server 14 populates the dynamic documents generated in step 202 with content received in step 204 and generates a table of contents. The content used by the electronic bidding server 14 to populate the dynamic documents can be submitted by the prime designer user of one of the client computing devices 12(1)-12(n) interacting with the front end web page 500, for example. Optionally, at least a portion of the project information submitted by the project administrator user in step 200 can also be used to populate one or more of the dynamic documents.

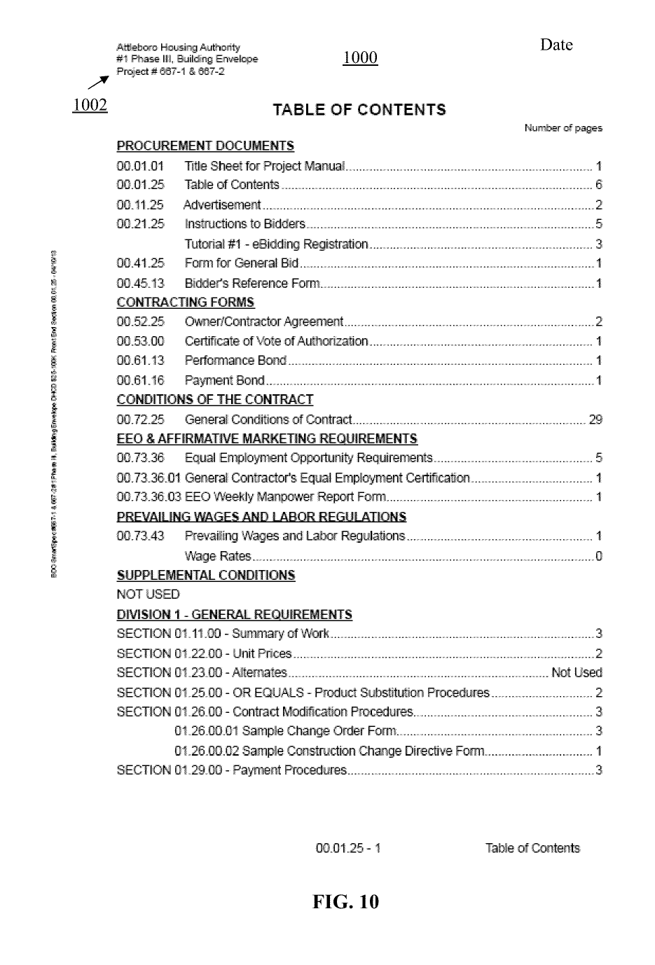

A first page 1000 of an exemplary table of contents generated in step 206 is illustrated in FIG. 10. In this example, each page of the table of contents includes a header automatically generated by the electronic bidding server 14. In this example, the header includes project information submitted by the project administrator user in step 200 and a date, although other information can be automatically inserted into the header or other portions of the table of contents by the electronic bidding server 14. The table of contents is generated based on the static and dynamic documents associated with the template as well as specifications and drawings submitted by the prime designer and/or consultant user(s) of the client computing devices 12(1)-12(n) in step 204. The drawings can be identified separately in the table of contents 1000 or as part of a drawing list that is also automatically generated by the electronic bidding server 14, for example.

Referring back to FIG. 2, in step 208, the electronic bidding server 14 receives a request from a prime designer user to submit the project for bidding. Upon selection of a design submission log tab 1100 of the plurality of tabs 414 by a prime designer user of one of the client computing devices 12(1)-12(n), the electronic bidding server 14 sends a design submission web page 1102 to the one of the client computing devices 12(1)-12(n). The design submission web page 1102 in this example includes an indication 1104 of project(s) associated with the prime designer user that are currently in progress and a send to bidding button 1106. Upon selection of the send to bidding button 1106 by the prime designer user, a create submission overlay 1108 is displayed on the one of the client computing devices 12(1)-12(n) associated with the prime designer user. The content of the create submission overlay 1108 can also be displayed to the user in a new tab, a new window, or any other type of display.

In this example, the create submission overlay 1108 includes a first plurality of input fields 1110 configured to receive parameter(s) (e.g., dates) to be used by the electronic bidding server 14 to make the project available for bidding. Optionally, the create submission 1108 overlay further includes a second plurality of input fields 1112 configured to receive other files not previously uploaded by a user associated with the project or received by the electronic bidding server 14 in step 204. Upon selection by the prime designer user of the save button 1114 of the create submission overlay 1108, a request is sent to the electronic bidding server 14. The request can include the content (e.g., parameters and/or files) inserted into the input fields of the create submission overlay 1108, which can be stored by the electronic bidding server 14 in the memory 30 as associated with the project.

Referring back to FIG. 2, in step 210, the electronic bidding server 14 determines whether the created submission is valid. In order to determine the validity of the submission, the electronic bidding server 14 determines whether or validates that the required input fields of the dynamic documents, as indicated in the template associated with the project, have been populated in step 206. Optionally, populated content is also analyzed to determine whether it satisfies required attributes of the input fields, as also indicated in the template.

In other examples, the validation of the dynamic documents can occur subsequent to populating the dynamic documents in step 208. Additionally, the validation of the content with respect to the required attributes can occur subsequent to submission by a user associated with the project interacting with the front end web page 500, for example. Also optionally, the electronic bidding server 14 can determine whether all required specifications, drawings, and/or other documents have received in step 204, as indicated in the template.

If the electronic bidding server 14 determines that the submission is not validated, then the No branch is taken to step 204 and additional and/or valid content, specifications, and/or drawings are submitted by user(s) associated with the project and received by the electronic bidding server 14, as described and illustrated earlier. Optionally, the electronic bidding server 14 can send a web page indicating the identified deficiencies to the one of the client computing devices 12(1)-12(n) associated with the prime designer user. If the electronic bidding server 14 determines that the submission is validated, then the Yes branch is taken to step 212.

In step 212, the electronic bidding server 14 provides the submission including the drawings, specifications, and static and dynamic documents associated with the project to an electronic bidding platform. Optionally, the electronic bidding server 14 can provide the submission to the electronic bidding platform when the parameters received upon submission of the content inserted into the input fields 1110 of the create submission overlay 1108 are satisfied.

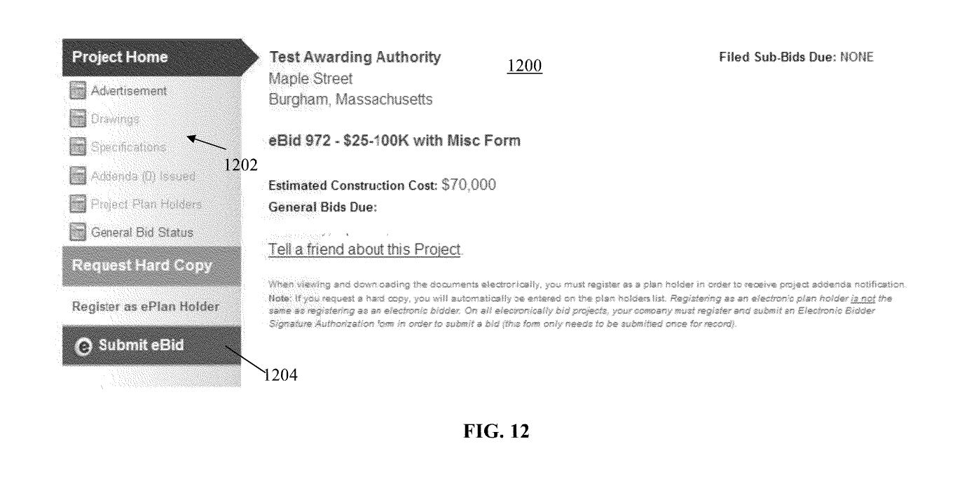

In step 214, the electronic bidding server 14 receives bids, such as bids from general contractors desiring to perform the construction work associated with the project. An exemplary electronic bidding web page 1200 of an electronic bidding platform for facilitating receipt of bids associated with a project is illustrated in FIG. 12. In this example, the electronic bidding web page 1200 includes a set of tabs 1202 that include links to the bid documents associated with the project and stored in the memory 30 of the electronic bidding server 14.

Additionally, the electronic bidding web page 1200 includes a submit eBid button 1204 that, when selected by an authorized user, is configured to retrieve a web page of the electronic bidding platform stored by the electronic bidding server 14 having input fields for receiving bids. Users can be authorized as disclosed in U.S. patent application Ser. No. 13/590,425, hereby incorporated by reference in its entirety, although other methods of authorizing and/or receiving bids can also be used. The bids received can be stored in the memory 30 of the electronic bidding server 14 as associated with the project and the user that submitted the bid.

Referring back to FIG. 2, in step 216, the electronic bidding server 14 receives an indication of an accepted one of the bids received in step 214. Accordingly, the electronic bidding server 14 can be configured to send the bids received in step 214, at the conclusion of a specific time period, to a user of one of the client computing devices 12(1)-12(n), such as the project administrator user, and receive an indication of an acceptance of one of the bids from the user.

In step 218, the electronic bidding server generates a contract based on the accepted bid and the user associated with the accepted bid. In some examples, dynamic document(s) associated with the project are used to generate the contract, such as the documents indicated in the contracting forms section of the front end pane 604, for example. In these examples, input fields of the dynamic documents can be populated according to the accepted bid and identifying information associated with the user that submitted the accepted bid.

In step 220, the electronic bidding server 14 stores the specifications, drawings, static and dynamic documents, and contract generated in step 218 in the memory 30 as associated with the project. Optionally, the archived documents can be stored for a specified period of time during which they are accessible to users having sufficient access privileges through the web-based platform.

By this technology, construction project document can be prepared automatically using a web-based platform that guides compliance with a template. The template can include requirements for static and dynamic documents and the content to be included in the dynamic documents. Users of the web-based platform are assigned privileges according to roles and the documents and contents submitted on behalf of an awarding authority by the users are validated and submitted for electronic bidding. Accordingly, with this technology, compliance with statutes or other regulations and accuracy of bid documents associated with construction projects is increased.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating the preparation of construction bid documents, the method comprising:
obtaining, with an electronic bidding server, a selection of a template associated with a project from a first user, wherein the template includes at least a plurality of static and dynamic documents and the first user is authenticated as an administrator of the project;
receiving, with the electronic bidding server, one or more drawings, one or more specifications, and content associated with the project from a second user, wherein the second user is identified by the first user as a prime designer associated with the project;
populating, with the electronic bidding server, one or more input fields of the one or more dynamic documents with the content received from the second user; and
providing, with the electronic bidding server, the one or more specifications, one or more drawings, and static and dynamic documents to a bidding platform configured to receive bids from one or more bidders for completing the project.

2. The method of claim 1, further comprising:
receiving, with the electronic bidding server, one or more bids from the one or more bidders submitted using the bidding platform;
receiving, with the electronic bidding server, an indication of an acceptance of one of the one or more bids from the first user; and
generating, with the electronic bidding server, a contract based on an accepted one of the one or more bids with one of the one or more bidders from which the accepted one of the one or more bids was received.

3. The method of claim 1, further comprising providing, with the electronic bidding server, the one or more specifications, one or more drawings, and static and dynamic documents in a viewable form to the first user or one or more third users, wherein each of the one or more third users are identified by the second user as a reviewer associated with the project.

4. The method of claim 1, wherein the receiving further comprises receiving one or more of the one or more drawings, one or more specifications from one or more fourth users, wherein each of the one or more fourth users are identified by the second user as a consultant associated with the project

5. The method of claim 1, further comprising generating, with the electronic bidding server, a table of contents identifying at least the static and dynamic documents and the one or more specifications, and including a drawing list identifying the one or more drawings.

6. The method of claim 1, wherein:
the template further includes an indication of the one or more input fields of the one or more dynamic documents that are required and one or more required attributes of at least the required input fields; and
the providing further comprises validating the one or more dynamic documents comprising determining whether each of the required input fields includes content and whether the content of each of the required input fields complies with an associated one or more of the one or more required attributes.

7. The method of claim 1, further comprising storing, with the electronic bidding server, at least the one or more specifications, one or more drawings, one or more static documents, one or more dynamic documents, and the generated contract in a memory as associated with an indication of the project.

8. A non-transitory computer readable medium having stored thereon instructions for facilitating the preparation of construction bid documents comprising machine executable code which when executed by a processor, causes the processor to perform steps comprising:
obtaining a selection of a template associated with a project from a first user, wherein the template includes at least a plurality of static and dynamic documents and the first user is authenticated as an administrator of the project;
receiving one or more drawings, one or more specifications, and content associated with the project from a second user, wherein the second user is identified by the first user as a prime designer associated with the project;
populating one or more input fields of the one or more dynamic documents with the content received from the second user; and
providing the one or more specifications, one or more drawings, and static and dynamic documents to a bidding platform configured to receive bids from one or more bidders for completing the project.

9. The medium of claim 8, further having stored thereon instructions that when executed by the processor cause the processor to perform steps further comprising:
receiving one or more bids from the one or more bidders submitted using the bidding platform;
receiving an indication of an acceptance of one of the one or more bids from the first user; and
generating a contract based on an accepted one of the one or more bids with one of the one or more bidders from which the accepted one of the one or more bids was received.

10. The medium of claim 8, further having stored thereon instructions that when executed by the processor cause the processor to perform steps further comprising providing the one or more specifications, one or more drawings, and static and dynamic documents in a viewable form to the first user or one or more third users, wherein each of the one or more third users are identified by the second user as a reviewer associated with the project.

11. The medium of claim 8, wherein the receiving further comprises receiving one or more of the one or more drawings, one or more specifications from one or more fourth users, wherein each of the one or more fourth users are identified by the second user as a consultant associated with the project.

12. The medium of claim 8, further having stored thereon instructions that when executed by the processor cause the processor to perform steps further comprising generating a table of contents identifying at least the static and dynamic documents and the one or more specifications, and including a drawing list identifying the one or more drawings.

13. The medium of claim 8, wherein:
the template further includes an indication of the one or more input fields of the one or more dynamic documents that are required and one or more required attributes of at least the required input fields; and
the providing further comprises validating the one or more dynamic documents comprising determining whether each of the required input fields includes content and whether the content of each of the required input fields complies with an associated one or more of the one or more required attributes.

14. The medium of claim 8, further having stored thereon instructions that when executed by the processor cause the processor to perform steps further comprising storing at least the one or more specifications, one or more drawings, one or more static documents, one or more dynamic documents, and the generated contract in a memory as associated with an indication of the project.

15. An electronic bidding server, comprising:
a processor coupled to a memory and configured to execute programmed instructions stored in the memory comprising:
obtaining a selection of a template associated with a project from a first user, wherein the template includes at least a plurality of static and dynamic documents and the first user is authenticated as an administrator of the project;
receiving one or more drawings, one or more specifications, and content associated with the project from a second user, wherein the second user is identified by the first user as a prime designer associated with the project;
populating one or more input fields of the one or more dynamic documents with the content received from the second user; and
providing the one or more specifications, one or more drawings, and static and dynamic documents to a bidding platform configured to receive bids from one or more bidders for completing the project.

16. The apparatus of claim 15, wherein the processor is further configured to execute programmed instructions stored in the memory further comprising:
receiving one or more bids from the one or more bidders submitted using the bidding platform;
receiving an indication of an acceptance of one of the one or more bids from the first user; and
generating a contract based on an accepted one of the one or more bids with one of the one or more bidders from which the accepted one of the one or more bids was received.

17. The apparatus of claim 15, wherein the processor is further configured to execute programmed instructions stored in the memory further comprising providing the one or more specifications, one or more drawings, and static and dynamic documents in a viewable form to the first user or one or more third users, wherein each of the one or more third users are identified by the second user as a reviewer associated with the project.

18. The apparatus of claim 15, wherein the receiving further comprises receiving one or more of the one or more drawings, one or more specifications from one or more fourth users, wherein each of the one or more fourth users are identified by the second user as a consultant associated with the project

19. The apparatus of claim 15, wherein the processor is further configured to execute programmed instructions stored in the memory further comprising generating a table of contents identifying at least the static and dynamic documents and the one or more specifications, and including a drawing list identifying the one or more drawings.

20. The apparatus of claim 15, wherein:
the template further includes an indication of the one or more input fields of the one or more dynamic documents that are required and one or more required attributes of at least the required input fields; and
the providing further comprises validating the one or more dynamic documents comprising determining whether each of the required input fields includes content and whether the content of each of the required input fields complies with an associated one or more of the one or more required attributes.

21. The apparatus of claim 15, wherein the processor is further configured to execute programmed instructions stored in the memory further comprising storing at least the one or more specifications, one or more drawings, one or more static documents, one or more dynamic documents, and the generated contract in a memory as associated with an indication of the project.
